(19) United States
(12) Patent Application Publication
(10) Pub. No.: US 2022/0339727 A1
(43) Pub. Date: Oct. 27, 2022

(54) CENTER SUPPORT FOR SUPPORTING SOLDER MATERIAL, TRANSPORT UNIT, AND SOLDERING SYSTEM HAVING A CENTER SUPPORT

(71) Applicant: ERSA GmbH, Wertheim (DE)

(72) Inventors: Benedict Fleischmann, Neubrunn (DE); Michael Haas, Schollbrunn (DE)

(73) Assignee: ERSA GmbH, Wertheim (DE)

(21) Appl. No.: 17/726,158

(22) Filed: Apr. 21, 2022

(30) Foreign Application Priority Data
Apr. 23, 2021 (DE) 10 2021 110 506.4

(51) Int. Cl. B23K 3/06

(52) U.S. Cl. CPC B23K 3/0638; B23K 2101/42

(57) ABSTRACT

Center support for supporting solder material during the transport along a transport direction through a soldering system, transport unit, and soldering system having such a center support.

### CROSS REFERENCE TO RELATED APPLICATIONS

The present application relates and claims priority to German Patent Application 10 2021 110 506.4 filed Apr. 23, 2021, the entire disclosures of which is hereby incorporated by reference in its entirety.

### BACKGROUND

The invention relates to a center support for supporting solder material during the transport along a transport direction through a soldering system. The solder material can be designed as a circuit board fitted with electronic components or as a goods carrier for goods, and in particular for circuit boards fitted with electronic components. The soldering system can in particular be a reflow soldering system for continuous soldering of circuit boards fitted with electronic components or a drying system for drying fitted circuit boards. The solder material is preferably supported in the center region. The center support has a main part and a drive part that is height-adjustable relative to the main part, wherein the drive part is adjustable between a transport position in which it acts against the solder material and a lowered position in which it does not act against the solder material.

The invention also relates to a transport unit having such a center support. While transport units without center support grip the respective solder material at the edges running parallel to the transport direction and convey it in the transport direction, the center support supports the solder material in the center region. Center supports are particularly advantageous when comparatively large circuit boards or goods carriers are to be soldered or dried. They prevent the solder material from bending or sagging in their center region, which can occur in particular due to the heating of the solder material, and thus ensure functionally reliable transport.

The invention also relates to a soldering system, in particular a reflow soldering system for continuous soldering of fitted circuit boards or a drying system for drying fitted circuit boards, in which solder material can be transported along a transport direction through at least one zone, wherein a transport unit having a center support or a center support is provided at least in the one zone. In particular, at least one preheating zone, at least one soldering zone and preferably also a cooling zone can be provided as zones in a process channel.

The post-published document DE 10 2019 128 780 A1 and CN° 101312618 A describe a transport unit for transporting circuit boards through a soldering system.

From DE 10 2005 055 283 A1, a height-adjustable center support is known which comprises a plate-link chain with a drive running on at least one drive wheel, wherein the plate-link chain is guided in a carrier. The provision of such a plate-link chain has proven to be problematic because it has to be lubricated continuously or at least very regularly and is susceptible to condensate and solder deposits.

A height-adjustable center support is also known from EP 970 773 B1, which, however, does not have a drive element for conveying the circuit boards.

By means of reflow soldering systems, in particular so-called SMD components (surface-mounted devices) are soldered onto the surface of circuit boards using solder paste. The solder paste, which is in particular a mixture of solder metal granulate, flux, and pasty components, is applied or printed onto the surface of the circuit boards for reflow soldering. The components to be soldered are then placed in the solder paste. In the reflow soldering process, the solder material, i.e., the assembly consisting of circuit board, solder paste and components to be soldered, is preheated along the process channel in the preheating zone and heated in the soldering zone to a temperature that is above the melting point of the solder paste. As a result, the solder paste melts and the solder joints are formed. In the cooling zone—if present—the solder material is cooled down until the molten solder solidifies before it is removed from the reflow soldering system.

In the case of reflow soldering systems, the process channel is covered by a covering hood in order to be able to provide the desired temperature profile and a defined atmosphere in the process channel. Furthermore, process gases form in the process channel, which can be discharged from the process channel and cleaned.

In order to achieve a better process result, it is known to provide a low-pressure chamber or a vacuum chamber in the soldering zone and to design it such that the soldering process takes place in the vacuum chamber with a negative pressure that is significantly below atmospheric pressure. This ensures that gas and air bubbles, flux residues and other contaminants are drawn off by the vacuum during the soldering process, which increases the quality of the solder joints. Accordingly, the quality of the solder joints can be improved by using a hyperbaric chamber within which the soldering process takes place.

Reflow soldering systems having vacuum chambers are known from DE 10 2009 028 865 B4 and DE 10 2019 125 983 A1. Reflow soldering systems providing a vacuum chamber and having a base part and a cover part in the form of a vacuum bell which can be raised relative to the base part are also known from DE 201 02 064 U1 and DE 199 11 887 C1. For moving the solder material in and out of the vacuum chamber, the cover part can be lifted off the base part.

### SUMMARY OF THE INVENTION

The problem addressed by the invention is that of providing a center support which reliably conveys the solder material in the transport direction and works permanently in a functionally reliable manner.

This problem is solved by a center support having the features of claim 1. It is therefore provided that the main part has at least one main part gear wheel and the drive part has at least one drive gear wheel that can be rotationally coupled to the main part gear wheel, that the drive gear wheel is rotationally coupled to drive rollers provided on the drive part, and that the drive rollers, in the transport position in which the main part gear wheel is rotationally coupled to the drive gear wheel, act against the solder material for supporting the transport of the solder material.

In contrast to the prior art, the main part has a drivable main part gear wheel which is rotationally coupled to the drive gear wheel on the drive part. As such, the drive gear wheel is rotationally coupled to the drive rollers, preferably without the use of a chain. It is designed in particular to be free of lubricants. In particular, further intermediate wheels can be provided between the drive gear wheel and the drive rollers, so that overall a plurality of drive rollers can be driven synchronously. The provision of wheels and rollers has the advantage that they are not subject to intensive lubrication and also comparatively resistant to condensate and solder residue.

Furthermore, it can advantageously be provided that a lowering mechanism, which can be actuated by means of a rotatably drivable actuating shaft, is provided between the main part and the drive part for moving the drive part between the transport position and the lowered position. This has the advantage that the center support can be lowered or raised automatically by driving the actuating shaft. If the actuating shaft is rotated in one direction, the drive part is moved into the transport position; if the actuating shaft is rotated in the other direction, the drive part is moved into the lowered position.

Advantageously, the lowering mechanism is motion-coupled to the actuating shaft and also designed such that it can be actuated during operation of the center support or the soldering system. This has the advantage that the center support can be moved during operation from the lowered position to the transport position or from the transport position to the lowered position. An interruption of the soldering process for this purpose is not required.

Furthermore, it is advantageous if the main part and the drive part are designed such that, in the lowered position, the drive gear wheel is rotationally decoupled from the main part gear wheel. This has the advantage that, in the lowered position, the drive gear wheel and the drive rollers motion-coupled thereto are not driven but can come to a standstill. If the center support is therefore not required, the drive rollers do not run in the lowered position.

The lowering mechanism can comprise at least one toothed rack which is provided on the drive part and extends in the vertical direction, and at least one lowering pinion which is rotatably arranged on the main part, meshes with the toothed rack and is drivable by the actuating shaft. Consequently, if the actuating shaft is rotated in one rotational direction, then the toothed rack is moved upwards to raise the drive part or downwards to lower the drive part.

It is also conceivable that the lowering mechanism comprises at least one pivot element which is arranged on the main part to be pivotable about a pivot axis between two pivot positions, wherein the pivot element acts on the drive part at a distance from the pivot axis such that, in one pivot position, the drive part is in the lowered position and in the other pivot position, the drive part is in the transport position. By pivoting the pivot element, the drive part is therefore either raised or lowered. In particular, the pivot axis can run transversely, or also parallel, to the transport direction.

For actuating the pivot element, a drive rod can be provided, which, at one end, acts eccentrically to the pivot axis on the pivot element and, at the other end, acts on an eccentric rotationally coupled to the actuating shaft. In this way, it can be achieved that, by rotating the actuating shaft, the drive rod carries out at least one movement component, as a result of which the pivot element is pivoted about the pivot axis. Consequently, the pivot element can overall be pivoted between the two pivot positions by rotating the actuating shaft via the drive rod, so that the drive part can be moved between the lowered position and the transport position. As a result, the pivot element can be arranged locally removed from the actuating shaft or the eccentric, resulting in greater flexibility in the arrangement of the components.

In particular, if the center support has a significant longitudinal extension, it is advantageous to provide a synchronization element which acts on at least two points on the drive part in order to effect a synchronized movement of the drive part. The synchronization element can act directly or indirectly on the drive part. In particular, it can be designed as a synchronization rod or a synchronization shaft.

In this case, two or more synchronously actuated pivot elements can then be provided. The drive part is then moved synchronously between the lowered position and the transport position not only at one point, but at two or more points by the synchronization element. The individual pivot elements can be motion-coupled by means of synchronization elements.

In another embodiment, the synchronization element can be designed as a synchronization rod which extends in the transport direction and in the regions facing away from one another, it has a pinion on which toothed racks provided on the drive part act. In this way, it is also possible to achieve a forced guidance of the drive unit, so that it is raised or lowered parallel to the transport direction.

Furthermore, it is advantageous if a drive shaft seat for a drive shaft extending transversely to the transport direction is provided on the main part for driving the main part wheel. The main part gear wheel, the drive gear wheel and the drive rollers coupled thereto can thus be driven via the drive shaft or the drive shaft seat.

It is also advantageous if an actuating shaft seat for the actuating shaft is provided on the main part, wherein the arrangement is in particular such that the actuating shaft extends transversely to the transport direction. The drive shaft then runs parallel to the actuating shaft. The drive part can be raised or lowered by rotating the actuating shaft.

The main part can be provided on a frame of a transport unit for transporting the solder material along the transport direction. The transport unit can in particular be designed such that it conveys the solder material at the free parallel edge regions in the transport direction. The center support is preferably provided in the central region of the transport unit or its frame.

The problem initially addressed is also solved by a transport unit for transporting solder material along a transport direction through at least one zone of a soldering system, wherein the transport unit comprises a center support according to the invention.

The problem initially addressed is also solved by a soldering system, in particular a reflow soldering system for continuous soldering of fitted circuit boards or a drying system for drying fitted circuit boards, having the features of claim 13. The solder material is transported through the system in a process channel along a transport direction, wherein at least one zone, in particular a preheating zone, a soldering zone and preferably also a cooling zone, is provided in the process channel. A transport unit according to the invention and/or a center support according to the invention is provided in the at least one zone.

It is particularly preferred if an openable vacuum chamber is provided in the soldering zone, wherein a transport unit according to the invention and/or a center support according to the invention is provided in the vacuum chamber. The vacuum chamber can have a base part and a cover part that can be raised relative to the base part when the soldering system is in operation. Such a soldering system—without a center support according to the invention—can in particular be a soldering system as shown in DE 10 2019 125 983 A1 by the applicant. For opening and closing the vacuum chamber, the vacuum chamber can also be provided with doors, slides, flaps or the like instead of the raisable cover part.

Such a design has the advantage that the center support can be moved between the transport position and the lowered position via a corresponding activation without opening the vacuum chamber and/or without stopping the transport of the solder material.

Further details and advantageous configurations of the invention can be found in the following description, on the basis of which embodiments of the invention are described and explained in more detail.

### BRIEF DESCRIPTION OF THE DRAWINGS

In the drawings:

FIG. 1 is a side view of a reflow soldering system;

FIG. 2 is a front view of the reflow soldering system according to FIG. 1;

FIG. 3 is a top view of part of the soldering zone of the reflow soldering system without a covering hood;

FIG. 4 is an isometric view of a side wall of a transport device having a center support, located in the soldering zone according to FIG. 3;

FIG. 5 is an enlarged view of the center support according to FIG. 4;

FIG. 6 shows the rear side of the center support according to FIG. 5;

FIG. 7 is an enlarged view of the lowering mechanism 110 from FIG. 5;

FIG. 8 is a view according to FIG. 7 with a reduced number of parts;

FIG. 9a shows a cross section of another transport device with the center support in the transport position;

FIG. 9b shows the transport unit according to FIG. 9a in the lowered position;

FIG. 10a is a side view of the center support according to FIG. 9a in the transport position;

FIG. 10b shows the transport unit according to FIG. 10a in the lowered position;

FIG. 11a shows the center support according to FIG. 10a without a housing cover in the transport position; and

FIG. 11b shows the transport unit according to FIG. 11a in the lowered position; and

FIG. 12 shows the lowering mechanism of the center support of the transport unit according to FIG. 9.

### DETAILED DESCRIPTION

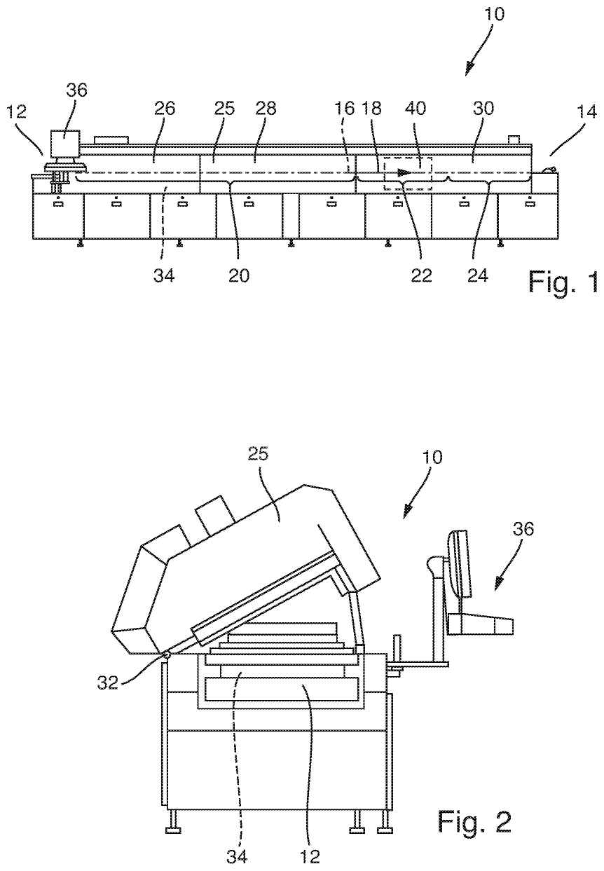

FIG. 1 shows a soldering system 10 in the form of a reflow soldering system for continuous soldering of solder material. The soldering system 10 has an inlet 12 and an outlet 14, wherein the solder material to be soldered enters the soldering system 10 via the inlet 12 and is removed from the soldering system 10 via the outlet 14. The solder material is transported through the soldering system 10 along a transport direction 18 of a process channel 16 indicated in FIG. 1.

A preheating zone 20, a soldering zone 22, and a cooling zone 24 are provided in the process channel 16. In the soldering system 10 shown in FIG. 1, a machine casing 25 with three portions 26, 28, and 30 for covering the process channel 16 is provided.

As is clear from FIGS. 1 and 2, a communication unit 36 is provided with a screen and an input device, by means of which communication can take place with a machine controller of the soldering system 10.

The solder material, i.e., the circuit board provided with solder paste and fitted with electronic components or a goods carrier carrying one or more circuit boards, is first heated in the preheating zone 20 to a temperature which is below the melting temperature of the solder paste. In the soldering zone 22, the circuit board is heated for a specific duration to a process temperature which is above the melting point of the solder paste, so that it melts in the soldering zone in order to solder the electronic components to the circuit board. The solder material is cooled in the cooling zone 24, so that the liquid solder solidifies before the solder material is removed at the outlet 14 of the soldering system 10.

A transport system 34 and a transport unit 50 are provided within the soldering system 10 for transporting the circuit boards along the transport direction 18.

As is clear from the front view of FIG. 2, the covering hood 25 can be pivoted upwards about a pivot axis 32 extending parallel to the transport direction 18. By pivoting the cover hood 25 upwards, the transport system 34 is accessible for a visual check, maintenance, cleaning, set-up, replacement and, if necessary, repairs.

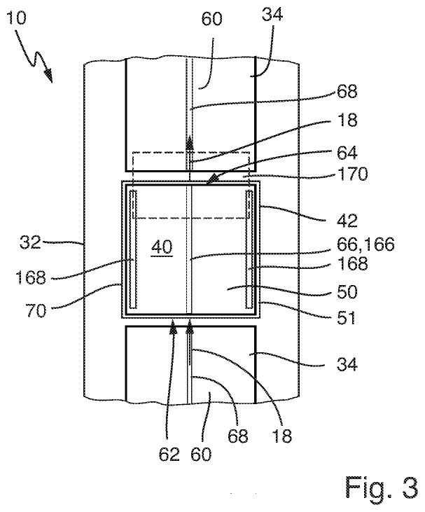

In the soldering zone 22, a low-pressure chamber in the form of a vacuum chamber 40 is located, which is formed by a base part 42 shown in the top view according to FIG. 3 and a cover part, not shown in the figures, with which the base part 42 can be closed.

When operating the soldering system 10, the cover part can be lifted off the base part 42 by means of a lifting mechanism. It is necessary to lift the cover part in order to be able to move the circuit boards into the vacuum chamber 40. As soon as the circuit boards are located in the vacuum chamber 40, the cover part is lowered so that it comes to rest on the base part 42. In a next step, the vacuum chamber 40 is evacuated with a vacuum pump (not depicted), so that a suitable vacuum is created in the vacuum chamber 40. Due to the negative pressure, in particular air inclusions in the liquid solder are expelled. After a brief application of negative pressure to the vacuum chamber 40, the cover part is raised via a corresponding activation of the lifting mechanism, so that the circuit boards can move out of the vacuum chamber 40. Advantageously, the circuit boards move through the vacuum chamber 40 within the described process at a constant or variable speed.

In the top view according to FIG. 3, the base part 42 of the vacuum chamber 40 and the transport unit 50 provided in the base part 42 are shown schematically. The vacuum chamber 40 provides a chamber entrance 62 in which circuit boards coming from the transport system 34 are transferred to the transport unit 50, and a chamber exit 64 in which the circuit boards are transferred back to the transport system 34. FIG. 3 shows in dashed lines a solder material 170 in the form of a fitted circuit board leaving the chamber exit 64.

The transport unit 50 preferably has a rectangular frame 51 which can be inserted into the vacuum chamber 40. Transport elements 168 running parallel to the transport direction 18 are preferably arranged on the frame 51 on the right and left, which transport the solder material 170 through the vacuum chamber 40 in the region of the free longitudinal edges running parallel to the transport direction 18. Furthermore, a center support 66, 166 is fastened to the frame 51. Correspondingly, the transport systems 34 also have transport elements (not depicted) running parallel to the transport direction 18 for conveying the circuit boards on the free longitudinal edges and the center supports 68.

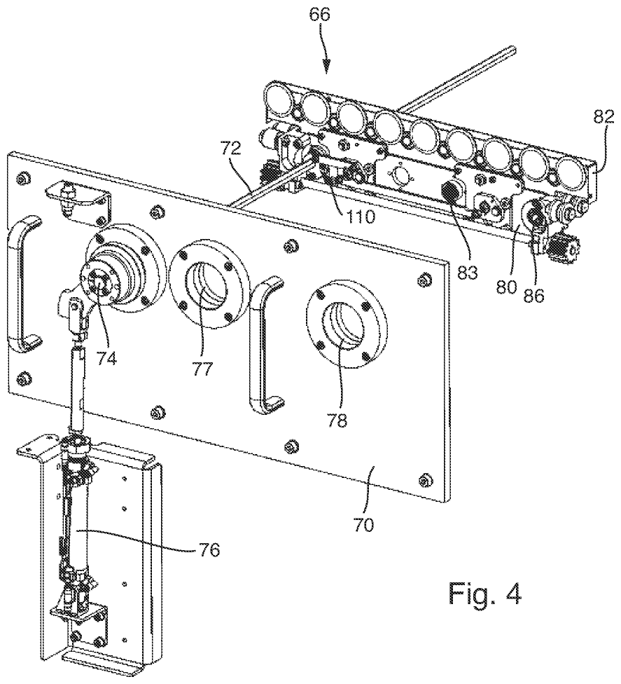

FIG. 4 shows the center support 66 and a side wall 70 of the vacuum chamber 40 or of the process channel. FIG. 4 also shows an actuating shaft 72 which extends through the side wall 70 in a pressure-sealed manner. The free end 74 of the actuating shaft 72 can be rotated by a lifting drive 76 arranged outside the vacuum chamber 40 about the longitudinal axis of the actuating shaft 72 by an actuating angle of, for example, 40° to 80°.

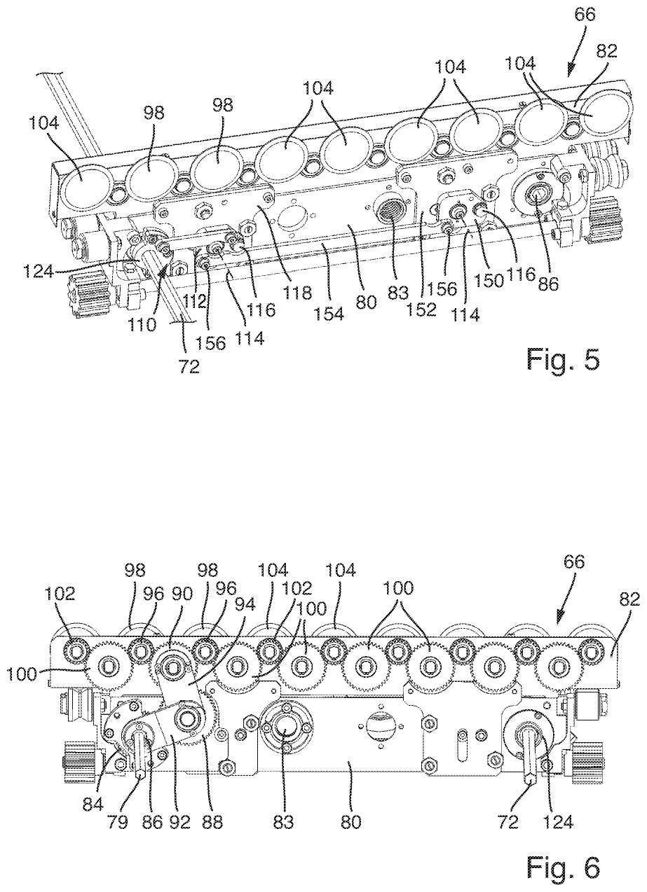

As is particularly clear from FIGS. 5 and 6, the center support 66 has a main part 80 and a drive part 82. In FIGS. 4, 5, and 6, the drive part 82 is shown in a lowered position. However, as described further below, by rotating the actuating shaft 72, the drive part 82 can be raised from the lowered position into a transport position in which, for transporting the solder material 170, it acts against the solder material 170 during operation of the center support.

The side wall 70 provides further openings 77, 78, through which further shafts can be guided out of the vacuum chamber 40 in a pressure-sealed manner. For example, a drivable drive shaft 79, shown in FIG. 6, can be guided through the opening 78 in order to convey solder material 170, as will be described further below. For example, a drivable center support adjustment shaft can be guided through the shaft opening 77 and interact with a rotary seat 81 provided on the main part 80. The arrangement can be such that the position of the center support 66 can be adjusted parallel to the transport direction 18 by rotating the center support adjustment shaft.

A main part gear wheel 84 is rotatably arranged on the main part 80 and has a drive shaft seat 86 in the form of a hexagonal opening. A drive shaft 79 shown in FIG. 6 can be inserted into the drive shaft seat 86. By rotating the drive shaft 79, the main part gear wheel 84 is thus rotated.

An intermediate gear wheel 88 is rotationally coupled to the main part gear wheel 84 and in turn meshes with a drive gear wheel 90. The drive gear wheel 90 is rotatably mounted on the drive part 82. As is clear from FIG. 6, the intermediate gear wheel 88 is movably connected to the main part 80 with a first swing arm 92 and to the drive part 82 with a second swing arm 94. The connection is such that the intermediate gear wheel 88 meshes with the main part gear wheel 84 and with the drive gear wheel 90 even if the drive part 82 is raised relative to the main part 80.

As is particularly clear from FIG. 6, the drive gear wheel 90 meshes with two pinions 96 which are each arranged on a shaft, which are each rotationally coupled to a drive roller 98, which can be seen clearly in particular in FIG. 5. The pinions 96 are in turn rotationally coupled to idler gears 100 which in turn are rotationally coupled to pinions 102. The pinions 102 drive shafts that are rotationally coupled to further drive rollers 104. Overall, all of the drive rollers 98 and 104 are rotationally coupled to one another, so that, when the main part gear wheel 84 is rotated, the drive rollers 104 are rotated accordingly.

For moving the drive part 82 between the transport position and the lowered position, a lowering mechanism 110 is provided, which can be seen in particular in FIG. 5. The lowering mechanism 110 can be actuated via the actuating shaft 72. If the actuating shaft 72 is rotated in the counterclockwise rotational direction, the drive part 82 is raised to the transport position; if, proceeding from the transport position, the actuating shaft 72 is rotated in the clockwise direction, the drive part 82 is transferred to the lowered position shown in FIG. 5.

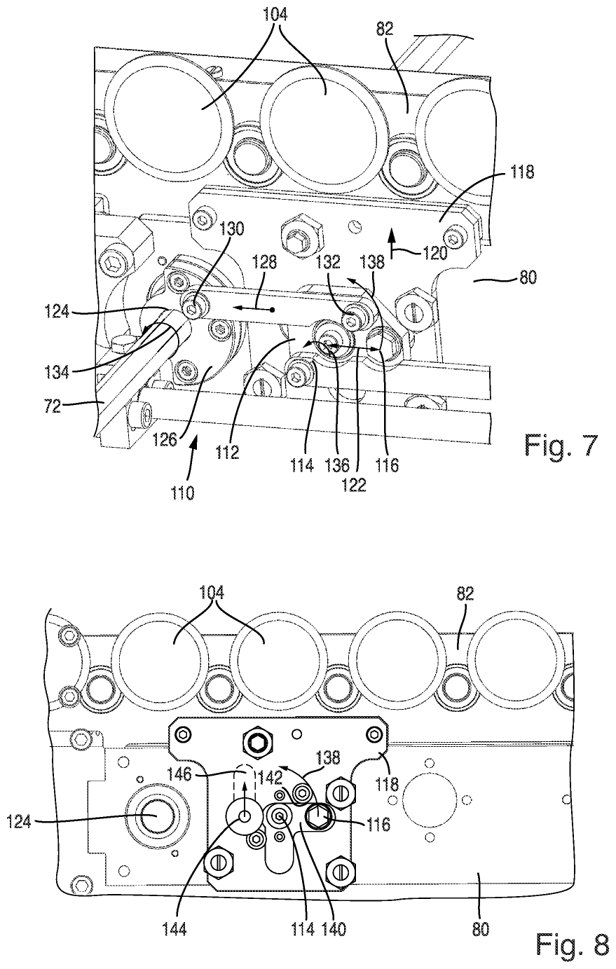

The lowering mechanism 110 shown in FIGS. 7 and 8 comprises a pivot element 112 which is arranged on the main part 80 to be pivotable about a pivot axis 114 running transversely to the transport direction 18. By means of a coupling screw 116, the pivot element 112 acts on the drive part 82 or on a vertically downwards extending drive part extension 118 of the drive part 82. For this purpose, the drive part extension 118 designed to be plate-like has a link groove 140, shown in FIG. 8, for receiving the coupling screw 116.

As is clear from FIG. 7, the lowering mechanism 110 also has an actuating shaft seat 124 provided on the main part 80, on which an eccentric 126 is arranged in a rotationally coupled manner. A drive rod 128 acts on the eccentric 126 eccentrically to the rotational axis of the actuating shaft 72. At the end of the drive rod 128 facing away from the eccentric 126, the drive rod acts on the pivot element 112 eccentrically to the pivot axis 114 in order to pivot the pivot element. For this purpose, the drive rod 128 is rotatably mounted on the eccentric 126 with a screw 130 and rotatably mounted on the pivot element 112 with a screw 132.

If, as indicated in FIG. 7, the actuating shaft 72 is rotated counterclockwise (arrow 134), the drive rod 128 is moved in parallel due to the motion coupling, so that the pivot element 112, corresponding to the eccentric 126, is ultimately also pivoted clockwise about the pivot axis 114 (arrow 136). Consequently, the coupling screw 116 is pivoted upwards along the arrow 138 from the first pivot position shown in FIG. 7, ultimately moving the drive part extension 118, and thus the drive part 82, vertically upwards along the arrow 120 into the raised transport position.

FIG. 8 shows the drive part extension 118 without the pivot element 112 and the drive rod 128. The link groove 140 of the drive part extension 118, which meshes with the coupling screw 116, can be seen. When the pivot element 112 is pivoted counterclockwise, the coupling screw 116 moves about the pivot axis 114 in accordance with the arrow 138. The coupling screw 116 now acts against the upper groove edge 142, thus raising the drive part extension 118. Upon further rotating, the coupling screw 116 migrates along the upper groove edge 114 of the link groove 140 from the right outer position of the link groove 140 shown in FIG. 8 towards the center region or the left end region of the link groove 140.

In order to ensure a purely vertical movement of the drive part extension 118, and thus of the drive part 82, a guide pin 144 is provided on the drive part extension 118, which meshes with a vertical groove 146 provided on the main part 80. When the pivot element 112 is pivoted, the drive part extension 118 is therefore forcibly guided vertically upwards until the drive part 82 reaches the transport position.

For moving the drive part 82 from the transport position into the lowered position, the actuating shaft 72 is rotated back clockwise in accordance with the movement sequence described, as a result of which the drive rod 128 is moved to the right and the pivot element 112 is then rotated clockwise. As a result, the coupling screw 116 moves downwards on its circular path around the pivot axis 114, thus moving the drive part extension 118 vertically downwards due to its forced guidance until the drive part 82 is in the lowered position.

As is clear from FIG. 5, a further pivot element 150 is provided on the main part next to the pivot element 112. Pivot element 150 is pivotable about a pivot axis 114 and, corresponding to pivot element 112, actuates a coupling screw 116 which is ultimately used to raise a further drive part extension 152, which is structured in accordance with drive part extension 118, into the transport position or lower it into the lowered position. A synchronization rod 154 is provided for the movement synchronization of the two pivot elements 112 and 115. The free ends of the synchronization rod 154 are fastened to the two pivot elements 112 and 150 by means of screws 156 and eccentrically to the respective pivot axis 114. The distance between the screws 156 and the respective pivot axes 114 corresponds to the distance 122 between the respective pivot axis 114 and the respective associated coupling screws 116. Overall, a synchronized movement of the two drive part extensions 118, and thus the movement of the drive part 82 over its entire longitudinal extension, can be achieved when the actuating shaft 72 is rotated.

Depending on the longitudinal extension of the center support 66, more than two pivot elements 112, 150 can also be used, which are then motion-coupled to one another via corresponding synchronization rods 154.

The center support shown in FIGS. 4 to 8 is provided to be used in a vacuum chamber as indicated in FIG. 3. The center support 66 described is designed to be very robust and, due to the use of gear wheels or pinions, can preferably be actuated without lubrication and during operation, it is adjustable between the lowered position and the transport position via the actuating shaft 72 and the associated lowering mechanism 110.

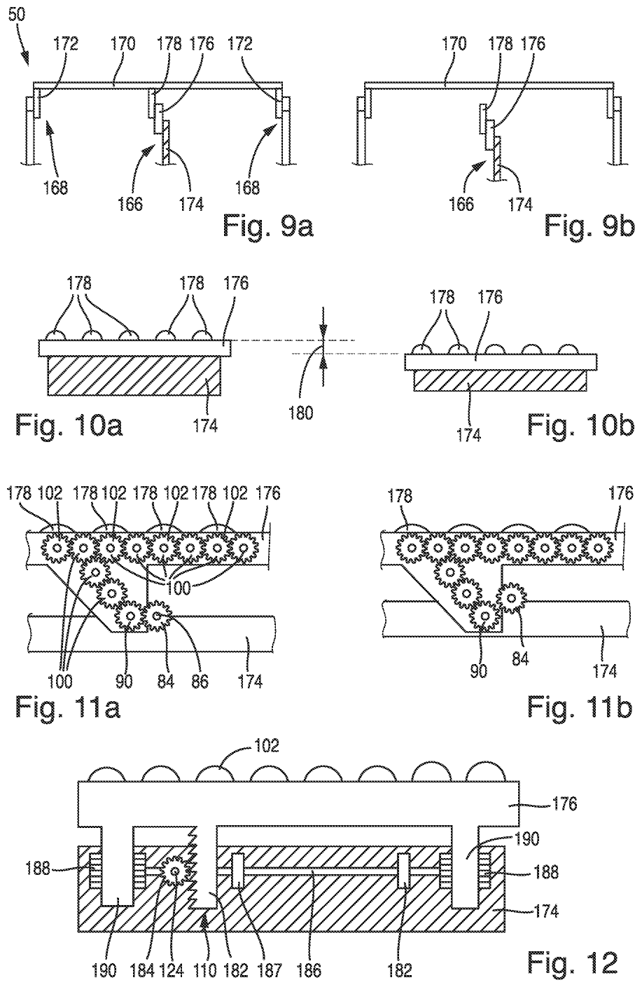

FIGS. 9 to 12 show a further embodiment of a center support 166, as can be used in the vacuum chamber 40 indicated in FIG. 3, the transport unit 50 and/or a transport system 34 according to FIG. 3.

FIG. 9a shows a cross section of a transport unit 50 having lateral transport elements 168 which can be designed, for example, as drivable drive rollers, by means of which the solder material 170 is conveyed in the transport direction in the region of the opposite longitudinal edges 172. The center support 166 is provided in the center region between the conveying elements 168 and supports the respective solder material 170 or the respective circuit board in the transport position in the center region.

FIG. 9a shows the center support 166 in its transport position in which it acts against the respective solder material 170. FIG. 9b shows the center support 166 in its lowered position in which it does not act against the respective solder material 170.

FIG. 10a is a side view of the center support 166 in the transport position. The center support 166 has a main part 174 and a drive part 176, wherein drivable drive rollers 178 are provided on the drive part 176. The drive part 176 with the drive rollers 178 can be moved from the transport position shown in FIG. 10a into the lowered position shown in FIG. 10b. The movement takes place in the vertical direction by a lowering distance 180.

In FIG. 11, which shows a longitudinal section of the center support 160, it becomes clear that a main part gear wheel 84 is provided on the main part 174, which meshes with a drive gear wheel 90 in the transport position. Downstream of the drive gear wheel are intermediate wheels 100 which ultimately drive pinions 102 which are non-rotatably arranged with the drive rollers 178 on a shaft. Intermediate wheels 100 are provided between the pinions 102 in accordance with the design according to the center support 66.

Corresponding to the design according to FIG. 6, the main part gear wheel 84 has a drive shaft seat 86 which meshes with a drive shaft (not depicted in FIGS. 9 to 12).

The design is such that, when the drive part 176 is moved into the lowered position, the drive gear wheel 90 is moved vertically downwards and, as shown in FIG. 11b, the main part gear wheel 84 is rotationally decoupled from the drive gear wheel 90. This design has the advantage that the drive rollers 178 are not driven in the lowered position. The drive rollers 178 consequently stand still in the lowered position. The arrangement is preferably such that, when the drive part 176 is moved into the transport position, the teeth of the main part gear wheel 84 automatically mesh with the teeth of the drive gear wheel 90.

FIG. 12 shows the lowering mechanism 110 for the drive part 176. A toothed rack 182 extending in the vertical direction is provided on the drive part 176. A lowering pinion 184 is provided on the main part 174, which provides an actuating shaft seat 124 for receiving an actuating shaft (not depicted in FIGS. 9 to 12). By rotating the actuating shaft running transversely to the transport direction, the drive part 176 can then be raised into the transport position or lowered into the lowered position.

In order to ensure synchronous movement of the drive part 176 over its longitudinal extension, a rotatably mounted synchronization shaft 186 can be provided on the main part 174. The synchronization shaft 186 can be rotatably mounted in two bearing blocks 187. As is clear from FIG. 12, the synchronization shaft 186 has a pinion 188 at each of its free ends, which in each case meshes with a toothed rack portion 190 which is provided on the drive part 176 and extends in the vertical direction. As a result, in particular, a jam-free raising and lowering that is synchronous over the longitudinal extension of the drive part 176 can be ensured.

1. Center support for supporting solder material during the transport along a transport direction through a soldering system,
wherein the center support has a main part and a drive part that is height-adjustable relative to the main part, wherein the drive part is adjustable between a transport position in which it acts against the solder material and a lowered position in which it does not act against the solder material, characterized in that
the main part has at least one main part gear wheel and the drive part has at least one drive gear wheel that can be rotationally coupled to the main part gear wheel,
that the drive gear wheel is rotationally coupled to drive rollers provided on the drive part, and that the drive rollers, in the transport position in which the main part gear wheel is rotationally coupled to the drive gear wheel, act against the solder material for supporting the transport of the solder material.

2. Center support according to claim 1, characterized in that a lowering mechanism, which can be actuated by means of a rotatably drivable actuating shaft, is provided between the main part and the drive part for moving the drive part between the transport position and the lowered position.

3. Center support according to claim 2, characterized in that the lowering mechanism is motion-coupled to the actuating shaft and designed such that it can be actuated during operation of the center support.

4. Center support according to claim 2, characterized in that the main part and the drive part are designed such that, in the lowered position, the drive gear wheel is rotationally decoupled from the main part gear wheel.

5. Center support according to claim 2, characterized in that the lowering mechanism has at least one toothed rack which is provided on the drive part and extends in the vertical direction, and at least one lowering pinion which is rotatably arranged on the main part, meshes with the toothed rack and is drivable by the actuating shaft.

6. Center support according to claim 2, characterized in that the lowering mechanism comprises at least one pivot element which is arranged on the main part to be pivotable about a pivot axis between two pivot positions,
wherein the pivot element acts on the drive part at a distance from the pivot axis such that, in one pivot position, the drive part is in the lowered position and in the other pivot position, the drive part is in the transport position.

7. Center support according to claim 6, characterized in that a drive rod is provided which, at one end, acts eccentrically to the pivot axis on the pivot element and, at the other end, acts on an eccentric rotationally coupled to the actuating shaft.

8. Center support according to claim 1, characterized in that a synchronization element is provided which acts on at least two points on the drive part in order to effect a synchronized movement of the drive part.

9. Center support according to claim 1, characterized in that a drive shaft seat for a drive shaft for driving the main part gear wheel is provided on the main part.

10. Center support according to claim 2, characterized in that an actuating shaft seat for the actuating shaft is provided on the main part, wherein the arrangement is such that the actuating shaft extends transversely to the transport direction.

11. Center support according to any of the preceding claims, characterized in that the main part is provided on a frame of a transport unit for transporting the solder material along the transport direction.

12. Transport unit for transporting solder material along a transport direction through at least one zone of a soldering system, comprising a center support according to claim 1.

13. Soldering system in which the solder material can be transported along a transport direction through at least one zone, characterized in that, in at least one of the zones, a transport unit is provided and comprises a center support for supporting the solder material during the transport along a transport direction through the soldering system,
wherein the center support has a main part and a drive part that is height-adjustable relative to the main part, wherein the drive part is adjustable between a transport position in which it acts against the solder material and a lowered position in which it does not act against the solder material, characterized in that
the main part has at least one main part gear wheel and the drive part has at least one drive gear wheel that can be rotationally coupled to the main part gear wheel,
that the drive gear wheel is rotationally coupled to drive rollers provided on the drive part, and that the drive rollers, in the transport position in which the main part gear wheel is rotationally coupled to the drive gear wheel, act against the solder material for supporting the transport of the solder material.

14. Soldering system according to claim 13, characterized in that one zone is designed as a soldering zone in which an openable vacuum chamber is provided.
